(19) United States
(12) Patent Application Publication
(10) Pub. No.: US 2012/0237694 A1
(43) Pub. Date: Sep. 20, 2012

(54) ALUMINUM ALLOY COATING PROCESS AND METHOD

(75) Inventors: Leland Lorentzen, Erie, CO (US); Mark Selepack, Longmont, CO (US)

(73) Assignee: Golden Aluminum, Inc., Fort Lupton, CO (US)

(21) Appl. No.: 13/353,216

(22) Filed: Jan. 18, 2012

Related U.S. Application Data
(60) Provisional application No. 61/434,339, filed on Jan. 19, 2011.
(60) Provisional application No. 61/434,724, filed on Jan. 20, 2011.
(60) Provisional application No. 61/482,517, filed on May 4, 2011.
(60) Provisional application No. 61/489,923, filed on May 25, 2011.
(60) Provisional application No. 61/490,474, filed on May 26, 2011.
(60) Provisional application No. 61/493,279, filed on Jun. 3, 2011.
(60) Provisional application No. 61/554,143, filed on Nov. 1, 2011.

(51) Int. Cl. B05D 3/06

(52) U.S. Cl. 427/551

(57) ABSTRACT

The present disclosure describes a coating process and product using ultraviolet or electron beam curing of a low magnesium aluminum alloy to produce a product having mechanical properties suitable for tab and end stock.

### CROSS-REFERENCE TO RELATED APPLICATIONS

The present application claims the benefits of U.S. Provisional Application Nos. 61/434,339, filed Jan. 19, 2011; 61/434,724, filed Jan. 20, 2011; 61/482,517, filed May 4, 2011; 61/489,923, filed May 25, 2011; 61/490,474, filed May 26, 2011; 61/493,279, filed Jun. 3, 2011; and 61/554,143, filed Nov. 1, 2011, all of which are incorporated herein by this reference in its entirety.

### FIELD

The invention relates generally to aluminum alloys and particularly to applying coatings to aluminum alloy sheet.

### BACKGROUND

Aluminum beverage containers are generally made in two pieces, one piece forming the container sidewalls and bottom (referred to herein as “container body”) and a second piece forming a container top. Generally, the container body is fabricated by forming a cup from a circular blank aluminum sheet (i.e., body stock) and then extending and thinning the sidewalls by passing the cup through a series of dies having progressively smaller bore sizes. This process is referred to as “drawing and ironing” the container body. The ends of the container are formed from end stock and attached to the container body. The tab on the upper container end that is used to provide an opening to dispense the contents of the container is formed from tab stock.

Aluminum alloy sheet can be formed from a variety of differing processes. Commonly, the aluminum alloy is cast as an ingot, billet, or slab, such as by direct chill casting, ingot casting, belt casting, roll casting, or block casting, and subjected to further process steps, such as hot and cold rolling, homogenization, and annealing, to produce aluminum alloy sheet having suitable properties for use as body, end, or tab stock. Because body, end, and tab stock will contact foods, it is coated with a food grade coating to prevent metal ions from the container migrating into the food stored in the container, better preserve the food contents, improve the contents taste characteristics, improve corrosion resistance, and improve formability and appearance of the metal.

Sheet coating is a continuous and highly automated process for coating metal before fabrication. With reference to FIG. 1, a coil of aluminum alloy sheet 100, up to 80 inches wide moving up to 1,000 feet per minute, is unwound or uncoiled in step 104. The coil of the aluminum alloy sheet is placed on an unwinder or decoiler, where the metal is observed for defects.

In steps 108 and 112, the aluminum alloy sheet is cleaned and chemically treated, respectively. Brushes can be used to physically remove contaminants from the sheet, or the metal may be abraded by flap sanders to further enhance the surface. Pretreatments may be used to enhance the bond between the metal and the later applied coating and to add any corrosion resistance. The type of chemical treatment varies with the type of aluminum alloy being used.

In optional step 116, the cleaned and pretreated aluminum alloy sheet is dried in an oven.

After drying, the aluminum alloy sheet is then optionally primed and coated in step 120 to produce a coated aluminum alloy sheet. The primer and coating are usually applied to both sides of the sheet. The pickup roll transfers the coating liquid from the pan to the applicator roll. The liquid is then pumped into the pan, and then overflows back to the supply reservoir, where it is remixed and filtered.

The direction of the rotation of the applicator roll plays a part in determining the type of coating. Reverse roller coating, when the applicator roll turns in the opposite direction of the strip, is used to apply thick coatings. Direct roller coating, turning in the same direction as the strip, is used for thinner coatings, 0.5 mils or less.

During priming and/or coating, volatile organic compounds (VOC's) are normally released into the air. Appropriate, expensive safety equipment is required to collect and dispense of the VOC's.

The coated aluminum alloy sheet is thermally (oven) cured in step 124. In the oven, the coated aluminum alloy sheet is cured at high temperatures (potentially in excess of the alloy's recrystallization temperature and commonly greater than about 250° F. (121° C.)) for about 15 to 30 seconds. The coated aluminum alloy strip exits the oven and is cooled or quenched with air and/or water.

Depending on the application, one or more coats (e.g., primer and top coat) are applied to each side of the sheet. Additional coatings require a pass through a second coating room and oven. The coated and cured sheet, or conventionally coated aluminum alloy sheet, exits the (final) oven and is cooled before inspection.

The conventionally coated aluminum alloy sheet is then lubricated, or waxed, in step 128 for later drawing and ironing operations and recoiled in step 132 to form the aluminum alloy product 136.

Although coil coating provides for controls that are virtually impossible to attain with most other coating processes, it has drawbacks. High temperature curing of the coating can cause recrystallization and/or alteration of the physical properties of the sheet and require post-curing quenching, leading to sheet distortions and formability and mechanical strength problems in downstream processing of the sheet. The coating line requires a substantial capital investment.

### SUMMARY

These and other needs are addressed by the various aspects, embodiments, and/or configurations disclosed herein. The disclosure is directed generally to the application of solids coating systems to aluminum alloy sheet. Solid coatings typically include monomers and/or oligomers that react to form solid coatings.

In an embodiment, a process includes the steps:

(a) receiving a cast aluminum alloy sheet, the aluminum alloy sheet comprising:
no more than about 6 wt % magnesium;
no more than about 1.8 wt. % by weight manganese;
no more than about 0.50 wt. % copper;
no more than about 1.8 wt. % silicon;
no more than about 0.40 wt. % chromium;
no more than about 2.8 wt. % zinc;
no more than about 0.10 wt. % nickel;
no more than about 1 wt. % iron;
no more than about 0.20 wt. % titanium; and
no more than about 0.15 wt. % other impurities;

(b) applying a coating composition to the aluminum alloy sheet; and

(c) curing the coating composition by at least one of ultraviolet light and an electron beam to form a coated aluminum alloy sheet.

In an embodiment, a process includes the steps:

(a) receiving a cast aluminum alloy sheet, the aluminum alloy sheet comprising:
no more than about 0.20 wt. % magnesium;
no more than about 0.30 wt. % by weight manganese;
no more than about 0.35 wt. % copper;
no more than about 0.10 wt. % silicon;
no more than about 0.10 wt. % chromium;
no more than about 0.35 wt. % zinc;
no more than about 0.05 wt. % nickel;
no more than about 0.10 wt. % iron;
no more than about 0.20 wt. % titanium; and
no more than about 0.05 wt. % other impurities;

(b) applying a coating composition to the aluminum alloy sheet; and

(c) curing the coating composition by at least one of ultraviolet light and an electron beam to form a coated aluminum alloy sheet.

In one configuration, the coated aluminum alloy sheet has an as-rolled (and before coating) and as coated (after coating) yield strength of at least about 7 ksi, an as-rolled (and before coating) and as coated (after coating) tensile strength of at least about 10 ksi, and/or an elongation of at least about 2%.

In another configuration, an as-rolled (and before coating) and as coated (after coating) yield strength of the aluminum alloy sheet differs no more than about 5% than the as-rolled (and before coating) and as coated (after coating) yield strength of the coated aluminum alloy sheet, and an as-rolled (and before coating) and as coated (after coating) yield strength of the aluminum alloy sheet differs no more than about 5% than the as-rolled (and before coating) and as coated (after coating) yield strength of the coated aluminum alloy sheet.

In an embodiment, a process includes the steps:

(a) receiving a cast aluminum alloy sheet, the aluminum alloy sheet comprising: from
no more than about 1.5 wt. % magnesium;
no more than about 1.8 wt. % by weight manganese;
no more than about 0.5 wt. % copper;
no more than about 1.8 wt. % silicon;
no more than about 0.40 wt. % chromium;
no more than about 0.1 wt. % zinc;
no more than about 0.1 wt. % nickel;
no more than about 1 wt. % iron;
no more than about 0.10 wt. % titanium; and
no more than about 0.20 wt. % other impurities;

(b) applying a coating composition to the aluminum alloy sheet; and

(c) curing the coating composition by at least one of ultraviolet light and an electron beam to form a coated aluminum alloy sheet.

In one configuration, the coated aluminum alloy sheet has an as-rolled (and before coating) and as coated (after coating) yield strength of at least about 11 ksi, an as-rolled (and before coating) and as coated (after coating) tensile strength of at least about 11 ksi, and an elongation of at least about 2%.

In an embodiment, a process includes the steps:

(a) receiving a cast aluminum alloy sheet, the aluminum alloy sheet comprising: from
no more than about 6 wt. % magnesium;
no more than about 1.4 wt. % by weight manganese;
no more than about 0.50 wt. % copper;
no more than about 1.4 wt. % silicon;
no more than about 0.35 wt. % chromium;
no more than about 2.8 wt. % zinc;
no more than about 0.05 wt. % nickel;
no more than about 1 wt. % iron;
no more than about 0.20 wt. % titanium; and
no more than about 0.15 wt. % other impurities;

(b) applying a coating composition to the aluminum alloy sheet; and

(c) curing the coating composition by at least one of ultraviolet light and an electron beam to form a coated aluminum alloy sheet.

In one configuration, the coated aluminum alloy sheet has an as-rolled (and before coating) and as coated (after coating) yield strength of at least about 15 ksi, an earing of no more than about 5% (endstock), no more than about 2% (body stock), and no more than about 2% (closure stock), an as-rolled (and before coating) and as coated (after coating) tensile strength of at least about 22 ksi, and an elongation of at least about 2%.

In some formulations, the coated aluminum alloy sheet produced by the process discussed herein can realize a selected set of mechanical properties with a lower magnesium content when compared to conventionally coated aluminum alloy sheet. Typically for a given as coated (after coating) tensile and/or yield strength and depending on the particular alloy involved, a coated aluminum alloy sheet (using the process discussed herein) can have a magnesium content that commonly is at least about 0.01 wt. %, more commonly at least about 0.05 wt. %, more commonly at least about 0.075 wt. %, more commonly at least about 0.10 wt. %, more commonly at least about 0.15 wt. %, more commonly at least about 0.20 wt. %, more commonly at least about 0.25 wt. %, more commonly at least about 0.30 wt. %, more commonly at least about 0.35 wt. %, and even more commonly at least about 0.40 wt. % less than the magnesium content required by a conventionally coated aluminum alloy sheet.

In other formulations, a given as coated (after coating) tensile and/or yield strength and depending on the particular alloy involved, a coated aluminum alloy sheet (using the process discussed herein) can have a magnesium content that commonly is at least about 0.4 wt. %, more commonly at least about 0.5 wt. %, more commonly at least about 0.6 wt. %, more commonly at least about 0.7 wt. %, more commonly at least about 0.8 wt. %, more commonly at least about 0.9 wt. %, more commonly at least about 1.0 wt. %, more commonly at least about 1.1 wt. %, more commonly at least about 1.2 wt. %, and even more commonly at least about 1.3 wt. % less than the magnesium content required by a conventionally coated aluminum alloy sheet.

In another embodiment, a cast product is provided that has one of the above alloy chemistries and one or more of the physical properties and includes a cross-linked cured coating.

The aspects, embodiments, and configurations can provide a number of advantages depending on the particular application. Compared to conventional heat curable coating lines, the process embodiment can avoid a drop in mechanical properties across the coating line, thereby permitting the use of a reduced magnesium content of the alloy. In other words, for a selected set of physical properties the alloy disclosed herein includes less magnesium, iron, silicon, copper, and/or manganese than known alloy compositions. The curing oven is eliminated, thereby inhibiting recrystallization of the alloy. The fast line speeds achieved with ultraviolet (“UV”) and electron beam (“EB”) curable coatings and the absence of thermal drying can result in a relatively cool coating and curing process. By way of illustration, the temperature gain through a conventional coating line is in the range of about 400 to about 500° F. while the temperature gain through a coating line as disclosed herein is typically no more than about 100° F., more typically no more than about 75° F., more typically no more than about 50° F., more typically no more than about 25° F., and even more typically no more than about 5° F. The coating line can start and stop without significant loss of metal through the line due to line length, ovens, and exit and entry accumulators. The coating films disclosed herein are substantially solventless and generally do not generate VOC's during coating application or curing, thereby avoiding the need for complex and expensive VOC control equipment. For example, UV curable coatings for metal can application has been reported by the EPA to contain less than 0.01 VOC/gallon of coating. UV curable coatings can eliminate the need for incinerator operation. The coating film can have strong adhesion to the alloy surface and eliminate the need for a conversion coating. Elimination of the conversion coating avoids the pollution effects of chromates (e.g., hexavalent and trivalent chromium), titanium, and phosphates on the environment and the need for expensive treatment procedures to reduce hexavalent chromium ions to trivalent chromium ions for waste disposal. The footprint of the coating line is reduced relative to conventional coating lines. Ultraviolet and electron beam curing equipment is much more compact than conventional drying ovens, and the solvent-free compositions require less storage space than solvent-based coatings providing a comparable dry film weight. The process embodiment can further obviate the need for an accumulator tower and uncoiler or recoiler. If individual sheets rather than a coil is being coated, the welder/joiner and shear can also be eliminated. Compared to conventional coating and curing systems, the process embodiment can have a reduced in-process inventory. A conventional thermal curing coating manufacturing process, requiring intermediate drying stages, can be converted into a single-step, in-line process with UV/EB curable coatings. The process embodiment can provide lower insurance costs and reduced handling hazards. Solventless UV/EB curable coatings are rated as non-flammable liquids. This can result in reduced insurance costs, less stringent storage requirements, and a reduction in handling hazards compared to flammable solvent-based coatings. The process embodiment can provide not only reduced capital costs but also reduced operating costs (e.g., electrical, gas, labor, and maintenance costs) compared to a conventional coating and curing system. Several studies show a significant reduction in energy costs can be achieved by switching from conventional thermal curing coatings to UV/EB curable coatings. Additional studies show that switching to UV/EB curable coatings is less expensive than converting an existing solvent-based coating operation into a VOC and HAP compliant operation.

These and other advantages will be apparent from the disclosure contained herein.

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X₁-Xₙ, Y₁-Yₘ, and Z₁-Z₀, the phrase is intended to refer to a single element selected from X, Y, and Z, a combination of elements selected from the same class (e.g., X₁ and X₂) as well as a combination of elements selected from two or more classes (e.g., Y₁ and Z₀).

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.’

The term “earing” is a mechanical property measured by the 45° earing or 45° rolling texture. Forty-five degrees refers to the position of the aluminum alloy sheet, which is 45° relative to the rolling direction. The value for the 45° earing is determined by measuring the height of the ears which stick up in a cup minus the height of the valleys between the ears. The difference is divided by the height of the valleys and multiplied by 100 to convert to a percentage.

The term “recrystallization” refers to a change in grain structure without a phase change as a result of heating the alloy above the alloy's recrystallization temperature.

The preceding is a simplified summary to provide an understanding of some aspects, embodiments, and/or configurations. This summary is neither an extensive nor exhaustive overview of the invention and its various aspects, embodiments, and/or configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and/or configurations are possible utilizing, alone or in combination, one or more of the features set forth above or described in detail below.

### BRIEF DESCRIPTION OF THE DRAWINGS

The accompanying drawings are incorporated into and form a part of the specification to illustrate several examples of the aspects, embodiments, and/or configurations disclosed herein. These drawings, together with the description, explain the principles of the aspects, embodiments, and/or configurations. The drawings simply illustrate preferred and alternative examples of how the aspects, embodiments, and/or configurations can be made and used and are not to be construed as limiting the aspects, embodiments, and/or configurations to only the illustrated and described examples. Further features and advantages will become apparent from the following, more detailed, description of the various aspects, embodiments, and/or configurations, as illustrated by the drawings referenced below.

FIG. 1 is a flow chart depicting a prior art coating process;

FIGS. 2A-B is a flow chart depicting a coating process according to an embodiment; and

FIG. 3 depicts a sectional view of an aluminum alloy product according to an embodiment.

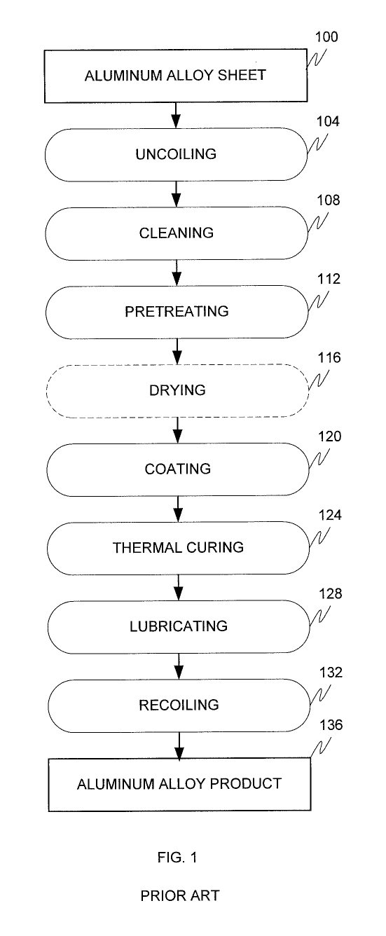

### DETAILED DESCRIPTION

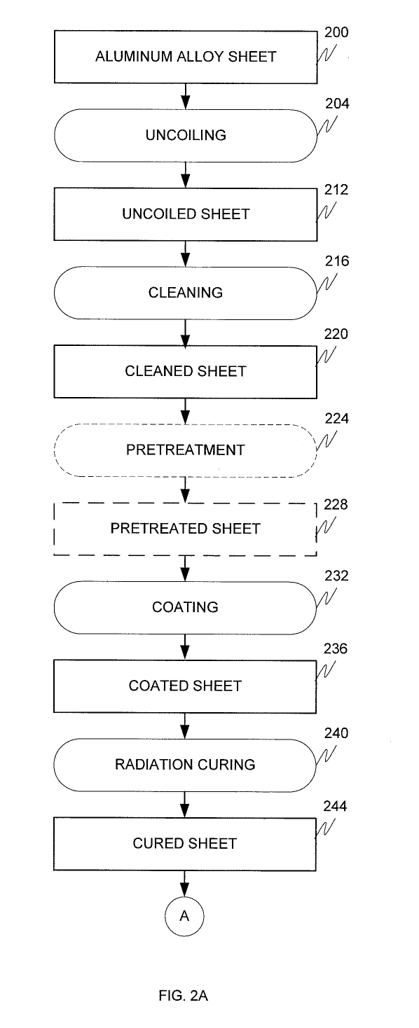

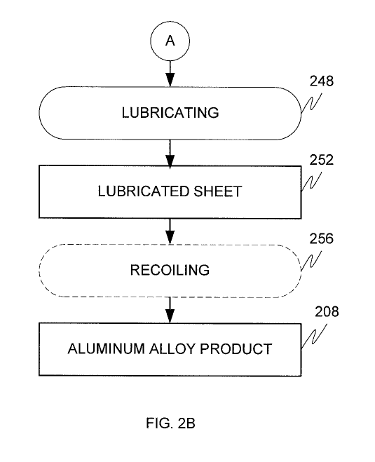

An embodiment of a process according to the disclosure will be discussed with reference to FIGS. 2A-B. The process is particularly applicable to aluminum alloys of the AA 1000, 3000, and 5000 series.

An aluminum alloy sheet 200 is provided. The sheet has been formed by a suitable process, such as casting and a combination of further processing steps, including one or more of homogenization, hot rolling, cold rolling, and annealing.

A 1000 series-based alloy has the following composition:

(i) no more than about 0.20 magnesium, even more commonly from about 0.05 to about 0.20, and even more commonly from about 0.10 to about 0.20% by weight magnesium;

(ii) no more than about 0.30, even more commonly from about 0.01 to about 0.20, and even more commonly from about 0.05 to about 0.20% by weight manganese;

(iii) no more than about 0.35, even more commonly from about 0.01 to about 0.25, even more commonly from about 0.05 to about 0.30, and even more commonly from about 0.10 to about 0.25% by weight copper;

(iv) no more than about 0.10, even more commonly from about 0.001 to about 0.08, and even more commonly from about 0.01 to about 0.07% by weight iron;

(v) no more than about 0.10, even more commonly from about 0.001 to about 0.02, and even more commonly from about 0.01 to about 0.02% by weight silicon;

(vi) no more than about 0.10, even more commonly from about 0.001 to about 0.095, and even more commonly from about 0.05 to about 0.085% by weight chromium;

(vii) no more than about 0.50, even more commonly from about 0.01 to about 0.45, and even more commonly from about 0.05 to about 0.40% by weight zinc;

(viii) no more than about 0.05, even more commonly from about 0.001 to about 0.045, and even more commonly from about 0.005 to about 0.04% by weight nickel;

(ix) no more than about 0.20, even more commonly from about 0.01 to about 0.175, and even more commonly from about 0.05 to about 0.15 wt. % titanium; and

(x) no more than about 0.05 wt. % other impurities.

An aluminum alloy product 208 produced from this alloy commonly has an as-rolled (and before coating) and as coated (after coating) yield strength of at least about 7 ksi, even more commonly ranges from about 7 to about 22 ksi, and even more commonly ranges from about 10 to about 22 ksi, an as-rolled (and before coating) and as coated (after coating) tensile strength of at least about 10 ksi, even more commonly ranges from about 10 to about 25 ksi, and even more commonly ranging from about 15 to about 25 ksi, and/or an elongation of at least about 2%, even more commonly of at least about 2.5%, and even more commonly of at least about 3%.

A 3000 series-based alloy has the following composition:

(i) no more than about 1.5 magnesium, even more commonly from about 0.01 to about 1.3, and even more commonly from about 0.05 to about 1.2% by weight magnesium;

(ii) no more than about 1.80, even more commonly from about 0.01 to about 1.3, and even more commonly from about 0.10 to about 1.0% by weight manganese;

(iii) no more than about 0.50, even more commonly from about 0.01 to about 0.3, and even more commonly from about 0.05 to about 0.25% by weight copper;

(iv) no more than about 1.00, even more commonly from about 0.1 to about 0.7, and even more commonly from about 0.25 to about 0.6% by weight iron;

(v) no more than about 1.80, even more commonly from about 0.10 to about 1.7, and even more commonly from about 0.25 to about 1.7% by weight silicon;

(vi) no more than about 0.40, even more commonly from about 0.01 to about 0.35, and even more commonly from about 0.05 to about 0.30% by weight chromium;

(vii) no more than about 0.10, even more commonly from about 0.001 to about 0.09, and even more commonly from about 0.005 to about 0.08% by weight zinc;

(viii) no more than about 0.10, even more commonly from about 0.001 to about 0.09, and even more commonly from about 0.005 to about 0.08% by weight nickel;

(ix) no more than about 0.10, even more commonly from about 0.001 to about 0.09, and even more commonly from about 0.005 to about 0.10 wt. % titanium; and

(x) no more than about 0.15 wt. % other impurities.

An aluminum alloy product 208 produced from this alloy commonly has an as-rolled (and before coating) and as coated (after coating) yield strength of at least about 11 ksi, even more commonly ranging from about 11 to about 40 ksi, and even more commonly ranging from about 15 to about 40 ksi, an as-rolled (and before coating) and as coated (after coating) tensile strength of at least about 11 ksi, even more commonly ranging from about 11 to about 42 ksi, and even more commonly ranging from about 15 to about 42 ksi, and/or an elongation of at least about 2%, even more commonly of at least about 2.5%, and even more commonly of at least about 3%.

A 5000 series-based alloy useful for producing tab or end stock has the following composition:

(i) no more than about 6.0, even more commonly from about 2.0 to about 5.0 and even more commonly from about 2.5 to about 4.8% by weight magnesium;

(ii) no more than about 1.40, even more commonly from about 0.10 to about 1.25, and even more commonly from about 0.10 to about 1.0% by weight manganese;

(iii) no more than about 0.50, even more commonly from about 0.001 to about 0.45, and even more commonly from about 0.01 to about 0.40% by weight copper;

(iv) no more than about 1.00, even more commonly from about 0.1 to about 0.85, and even more commonly from about 0.15 to about 0.75% by weight iron;

(v) no more than about 1.40, even more commonly from about 0.1 to about 1.3, and even more commonly from about 0.2 to about 1.2% by weight silicon;

(vi) no more than about 0.35, even more commonly from about 0.01 to about 0.3, and even more commonly from about 0.015 to about 0.25% by weight chromium;

(vii) no more than about 2.80, even more commonly from about 0.75 to about 2.7, and even more commonly from about 1.0 to about 2.6% by weight zinc;

(viii) no more than about 0.05, even more commonly from about 0.001 to about 0.045, and even more commonly from about 0.005 to about 0.04% by weight nickel;

(ix) no more than about 0.20, even more commonly from about 0.01 to about 0.175, and even more commonly from about 0.05 to about 0.15 wt. % titanium; and

(x) no more than about 0.15 wt. % other impurities.

An aluminum alloy product 208 produced from this alloy commonly has an as-rolled (and before coating) and as coated (after coating) yield strength of at least about 15 ksi, even more commonly ranging from about 15 to about 53 ksi, and even more commonly ranging from about 20 to about 53 ksi, an as-rolled (and before coating) and as coated (after coating) tensile strength of at least about 22 ksi, even more commonly ranging from about 22 to about 60 ksi, and even more commonly ranging from about 30 to about 60 ksi, and/or an elongation of at least about 2%, even more commonly at least about 2.5%, and even more commonly of at least about 3%.

For making aluminum alloy products suitable for shaping into food container bodies or food or beverage container end panels, a preferred alloy of the AA 5000 series is AA 5352, AA 5182, AA 5042, and AA 5017.

A 5352 series-based alloy useful for producing body stock has the following composition:

(i) from about 1.5 to about 3%, even more commonly from about 1.7 to about 2.8, and even more commonly from about 1.8 to about 2.7% by weight magnesium;

(ii) from about 0.001 to about 0.10%, even more commonly from about 0.005 to about 0.90, and even more commonly from about 0.01 to about 0.80% by weight manganese;

(iii) from about 0.001 to about 0.12%, even more commonly from about 0.005 to about 0.10, and even more commonly from about 0.01 to about 0.80% by weight copper;

(iv) from about 0.01 to about 0.30%, even more commonly from about 0.05 to about 0.25, and even more commonly from about 0.10 to about 0.20% by weight iron; and

(v) from about 0.01 to about 0.20%, even more commonly from about 0.05 to about 0.15, and even more commonly from about 0.025 to about 0.14% by weight silicon;

(vi) from about 0.001 to about 0.10%, even more commonly from about 0.0025 to about 0.09, and even more commonly from about 0.005 to about 0.085% by weight chromium;

(vii) from about 0.001 to about 0.10%, even more commonly from about 0.0025 to about 0.09, and even more commonly from about 0.005 to about 0.085% by weight zinc; and

(ix) from about 0.001 to about 0.10%, even more commonly from about 0.0025 to about 0.09, and even more commonly from about 0.005 to about 0.085% by weight titanium.

For a 180-degree pull direction, an aluminum alloy product 208 produced from this alloy commonly has an average as-rolled (and before coating) and as coated (after coating) yield strength of at least about 20 ksi, even more commonly of at least about 24 ksi, and even more commonly of at least about 25 ksi, and typically no more than about 36 ksi, an average as-rolled (and before coating) and as coated (after coating) tensile strength of at least about 30 ksi, even more commonly of at least about 35 ksi and even more commonly of at least about 37 ksi, and typically of no more than about 42 ksi, an average earing of no more than about 2% and even more commonly of no more than about 1.8%, an average peak metal temperature (“PMT”), of at least about 400° F., even more commonly of at least about 410° F., and even more commonly of at least about 420° F., and/or an average elongation of at least about 4%, even more commonly of at least about 5%, and even more commonly of at least about 6%.

A 5352 series-based alloy useful for producing end stock has the following composition:

(i) from about 2.0 to about 3%, even more commonly from about 2.2 to about 2.8, and even more commonly from about 2.3 to about 2.7% by weight magnesium;

(ii) from about 0.001 to about 0.10%, even more commonly from about 0.005 to about 0.90, and even more commonly from about 0.01 to about 0.80% by weight manganese;

(iii) from about 0.001 to about 0.12%, even more commonly from about 0.005 to about 0.10, and even more commonly from about 0.01 to about 0.80% by weight copper;

(iv) from about 0.01 to about 0.30%, even more commonly from about 0.05 to about 0.25, and even more commonly from about 0.10 to about 0.20% by weight iron; and

(v) from about 0.01 to about 0.20%, even more commonly from about 0.05 to about 0.15, and even more commonly from about 0.025 to about 0.14% by weight silicon;

(vi) from about 0.001 to about 0.10%, even more commonly from about 0.0025 to about 0.09, and even more commonly from about 0.005 to about 0.085% by weight chromium;

(vii) from about 0.001 to about 0.10%, even more commonly from about 0.0025 to about 0.09, and even more commonly from about 0.005 to about 0.085% by weight zinc; and

(ix) from about 0.001 to about 0.10%, even more commonly from about 0.0025 to about 0.09, and even more commonly from about 0.005 to about 0.085% by weight titanium.

For a 180-degree pull direction, an aluminum alloy product 208 produced from this alloy commonly has an average as-rolled (and before coating) and as coated (after coating) yield strength of at least about 25 ksi, even more commonly of at least about 30 ksi, and even more commonly of at least about 35 ksi, an average as-rolled (and before coating) and as coated (after coating) tensile strength of at least about 30 ksi, even more commonly of at least about 35 ksi and even more commonly of at least about 40 ksi, an average earing of no more than about 5% and even more commonly of no more than about 4%, an average PMT of at least about 400° F., even more commonly of at least about 425° F., and even more commonly of at least about 450° F., and/or an average elongation of at least about 3%, even more commonly of at least about 4%, and even more commonly of at least about 5%.

A 5352 series-based alloy useful for producing closure stock has the following composition:

(i) from about 2.0 to about 3%, even more commonly from about 2.2 to about 2.8, and even more commonly from about 2.3 to about 2.7% by weight magnesium;

(ii) from about 0.001 to about 0.12%, even more commonly from about 0.005 to about 0.11, and even more commonly from about 0.01 to about 0.10% by weight manganese;

(iii) from about 0.001 to about 0.1%, even more commonly from about 0.005 to about 0.9, and even more commonly from about 0.01 to about 0.80% by weight copper;

(iv) from about 0.01 to about 0.30%, even more commonly from about 0.05 to about 0.25, and even more commonly from about 0.10 to about 0.20% by weight iron; and

(v) from about 0.01 to about 0.15%, even more commonly from about 0.05 to about 0.14, and even more commonly from about 0.025 to about 0.13% by weight silicon;

(vi) from about 0.001 to about 0.10%, even more commonly from about 0.0025 to about 0.09, and even more commonly from about 0.005 to about 0.085% by weight chromium;

(vii) from about 0.001 to about 0.10%, even more commonly from about 0.0025 to about 0.09, and even more commonly from about 0.005 to about 0.085% by weight zinc; and

(ix) from about 0.001 to about 0.10%, even more commonly from about 0.0025 to about 0.09, and even more commonly from about 0.005 to about 0.085% by weight titanium.

For a 180-degree pull direction, an aluminum alloy product 208 produced from this alloy commonly has an average as-rolled (and before coating) and as coated (after coating) yield strength of at least about 15 ksi, even more commonly of at least about 20 ksi, and even more commonly of at least about 25 ksi, an average as-rolled (and before coating) and as coated (after coating) tensile strength of at least about 25 ksi, even more commonly of at least about 30 and even more commonly of at least about 32.5 ksi, an average earing of no more than about 2% and even more commonly of no more than about 1.8%, an average PMT of at least about 400° F., even more commonly of at least about 425° F. ksi, and even more commonly of at least about 450° F., and/or an average elongation of at least about 7%, even more commonly of at least about 8%, and even more commonly of at least about 9%.

A 5182 series-based alloy (e.g., AA 5182ES and SP) useful for producing end stock has the following composition:

(i) from about 0.20 to about 0.50%, even more commonly from about 0.225 to about 0.45, and even more commonly from about 0.250 to about 0.35% by weight manganese;

(ii) from about 4.0 to about 4.95%, even more commonly from about 4.5 to about 5, and even more commonly from about 4.7 to about 4.95% by weight magnesium;

(iii) from about 0.001 to about 0.15%, even more commonly from about 0.005 to about 0.11, and even more commonly from about 0.01 to about 0.08% by weight copper;

(iv) from about 0.01 to about 0.35%, even more commonly from about 0.015 to about 0.30, and even more commonly from about 0.020 to about 0.25% by weight iron; and

(v) from about 0.01 to about 0.20%, even more commonly from about 0.015 to about 0.175, and even more commonly from about 0.05 to about 0.15% by weight silicon;

(vi) from about 0.01 to about 0.25%, even more commonly from about 0.025 to about 0.15, and even more commonly from about 0.05 to about 0.1% by weight chromium;

(vii) from about 0.01 to about 0.25%, even more commonly from about 0.051 to about 0.20, and even more commonly from about 0.075 to about 0.175% by weight zinc;

(vii) from about 0.001 to about 0.01% and even more commonly from about 0.001 to about 0.075% by weight nickel; and

(viii) from about 0.001 to about 0.1%, even more commonly from about 0.005 to about 0.075, and even more commonly from about 0.01 to about 0.07% by weight titanium.

For a 45-degree pull direction, a coated aluminum alloy product 208 produced from this alloy commonly has an average as-rolled (and before coating) and as coated (after coating) yield strength of at least about 35 ksi, even more commonly of at least about 40 ksi, more commonly of at least about 45 ksi, and even more commonly of at least about 48.5 ksi, and commonly no more than about 52.5 ksi, an average as-rolled (and before coating) and as coated (after coating) tensile strength of at least about 45 ksi, even more commonly of at least about 50 ksi, more commonly of at least about 51 ksi, and even more commonly of at least about 54 ksi, and commonly no more than about 59 ksi, an average earing of no more than about 5% and even more commonly of no more than about 4.5%, an average PMT of at least about 400° F., even more commonly of at least about 420° F., and even more commonly of at least about 430° F., and/or an elongation of at least about 5%, even more commonly of at least about 8%, and even more commonly of at least about 9%. For a 180 degree pull direction, the coated aluminum alloy product 208 has an average yield strength in the range of from about 46 to about 57 ksi and an average tensile strength in the range of from about 53 to about 59 ksi.

A 5182 series-based alloy (e.g., AA 5182SP and FE) useful for producing tab stock has the following composition:

(i) from about 0.20 to about 0.50%, even more commonly from about 0.225 to about 0.45, and even more commonly from about 0.250 to about 0.35% by weight manganese;

(ii) from about 4.0 to about 5%, even more commonly from about 4.2 to about 4.8, and even more commonly from about 4.3 to about 4.6% by weight magnesium or in an alternative formulation even more commonly from about 4.8 to about 4.95% by weight magnesium;

(iii) from about 0.001 to about 0.1%, even more commonly from about 0.005 to about 0.09, and even more commonly from about 0.01 to about 0.08% by weight copper;

(iv) from about 0.01 to about 0.35%, even more commonly from about 0.015 to about 0.30, and even more commonly from about 0.020 to about 0.29% by weight iron; and

(v) from about 0.01 to about 0.20%, even more commonly from about 0.015 to about 0.175, and even more commonly from about 0.05 to about 0.15% by weight silicon;

(vi) from about 0.01 to about 0.25%, even more commonly from about 0.025 to about 0.15, and even more commonly from about 0.05 to about 0.1% by weight chromium;

(vii) from about 0.01 to about 0.25%, even more commonly from about 0.051 to about 0.20, and even more commonly from about 0.075 to about 0.175% by weight zinc;

(vii) from about 0.001 to about 0.01% and even more commonly from about 0.001 to about 0.075% by weight nickel; and

(viii) from about 0.001 to about 0.1%, even more commonly from about 0.005 to about 0.075, and even more commonly from about 0.01 to about 0.07% by weight titanium.

For a 180-degree pull direction, a coated aluminum alloy product 208 produced from this alloy commonly has an average as-rolled (and before coating) and as coated (after coating) yield strength of at least about 35 ksi, even more commonly of at least about 40 ksi and even more commonly of at least about 45.5 ksi, and commonly no more than about 55 ksi, and even more commonly no more than about 49 ksi, an average as-rolled (and before coating) and as-cured tensile strength of at least about 40 ksi, even more commonly of at least about 45 ksi, and even more commonly of at least about 52 ksi, and commonly no more than about 60 ksi and even more commonly no more than about 59 ksi, an average PMT of at least about 400° F., more commonly of at least about 420° F., and even more commonly of at least about 450° F., and/or an average elongation of at least about 5%, even more commonly of at least about 6%, and even more commonly of at least about 7%.

A 5182M8 series-based alloy useful for producing tab stock has the following composition:

(i) from about 0.20 to about 0.50%, even more commonly from about 0.25 to about 0.45, and even more commonly from about 0.275 to about 0.425% by weight manganese;

(ii) from about 4 to about 5%, even more commonly from about 4.1 to about 4.7, and even more commonly from about 4.15 to about 4.5% by weight magnesium;

(iii) from about 0.001 to about 0.1%, even more commonly from about 0.01 to about 0.09, and even more commonly from about 0.015 to about 0.08% by weight copper;

(iv) from about 0.01 to about 0.35%, even more commonly from about 0.050 to about 0.30, and even more commonly from about 0.075 to about 0.25% by weight iron; and

(v) from about 0.001 to about 0.20%, even more commonly from about 0.01 to about 0.175, and even more commonly from about 0.05 to about 0.15% by weight silicon;

(vi) from about 0.001 to about 0.1%, even more commonly from about 0.01 to about 0.075, and even more commonly from about 0.025 to about 0.050% by weight chromium;

(vii) from about 0.001 to about 0.01% by weight nickel;

(viii) from about 0.001 to about 0.1%, even more commonly from about 0.01 to about 0.09, and even more commonly from about 0.015 to about 0.08% by weight titanium; and

(ix) from about 0.01 to about 0.25%, even more commonly from about 0.015 to about 0.20, and even more commonly from about 0.025 to about 0.15% by weight zinc.

For a 180-degree direction of pull, an aluminum alloy product 208 produced from this alloy commonly has an average as-rolled (and before coating) and as-cured yield strength of at least about 35 ksi, even more commonly of at least about 40 ksi, and even more commonly of at least about 48 ksi, an average as-rolled (and before coating) and as-cured tensile strength of at least about 45 ksi, even more commonly of at least about 50 ksi, and even more commonly of at least about 57 ksi, an average PMT of at least about 400° F., even more commonly of at least about 410° F., and even more commonly of at least about 420° F., and/or an average elongation of at least about 5%, even more commonly of at least about 6%, and even more commonly of at least about 7%.

A 5017 series-based alloy useful for producing body stock has the following composition:

(i) from about 0.45 to about 0.80%, even more commonly from about 0.4 to about 0.70, and even more commonly from about 0.5 to about 0.60% by weight manganese;

(ii) from about 1.5 to about 2.25%, even more commonly from about 1.5 to about 2, and even more commonly from about 1.6 to about 1.9% by weight magnesium;

(iii) from about 0.1 to about 0.30%, even more commonly from about 0.18 to about 0.28, and even more commonly from about 0.16 to about 0.27% by weight copper;

(iv) from about 0.01 to about 0.70%, even more commonly from about 0.015 to about 0.60, and even more commonly from about 0.020 to about 0.50% by weight iron; and

(v) from about 0.01 to about 0.40%, even more commonly from about 0.015 to about 0.35, and even more commonly from about 0.05 to about 0.30% by weight silicon;

(vi) no more than about 0.001% by weight chromium;

(vii) no more than about 0.001% by weight zinc;

(vii) no more than about 0.001% by weight nickel; and

(viii) from about 0.001 to about 0.1%, even more commonly from about 0.005 to about 0.09, and even more commonly from about 0.001 to about 0.08% by weight titanium.

For a 180-degree pull direction, an aluminum alloy product 208 produced from this alloy commonly has an average as-rolled (and before coating) and as-cured yield strength of at least about 25 ksi, even more commonly of at least about 30 ksi and even more commonly of at least about 35 ksi, an average as-rolled (and before coating) and as-cured tensile strength of at least about 30 ksi, even more commonly of at least about 35 ksi, and even more commonly of at least about 40 ksi, an average earing of no more than about 2% and even more commonly of no more than about 1.8%, an average PMT of at least about 500° F., even more commonly of at least about 510° F., and even more commonly of at least about 525° F., and/or an elongation of at least about 5.5%, even more commonly of at least about 5.75%, and even more commonly of at least about 6%.

A 5017 series-based alloy useful for producing end stock has the following composition:

(i) from about 0.45 to about 0.80%, even more commonly from about 0.4 to about 0.70, and even more commonly from about 0.5 to about 0.60% by weight manganese;

(ii) from about 1 to about 2.25%, even more commonly from about 1.2 to about 2, and even more commonly from about 1.6 to about 1.9% by weight magnesium;

(iii) from about 0.1 to about 0.30%, even more commonly from about 0.18 to about 0.28, and even more commonly from about 0.16 to about 0.27% by weight copper;

(iv) from about 0.01 to about 0.70%, even more commonly from about 0.015 to about 0.60, and even more commonly from about 0.020 to about 0.50% by weight iron; and

(v) from about 0.01 to about 0.40%, even more commonly from about 0.015 to about 0.35, and even more commonly from about 0.05 to about 0.30% by weight silicon;

(vi) no more than about 0.001% by weight chromium;

(vii) no more than about 0.001% by weight zinc;

(vii) no more than about 0.001% by weight nickel; and

(viii) from about 0.001 to about 0.1%, even more commonly from about 0.005 to about 0.09, and even more commonly from about 0.001 to about 0.08% by weight titanium.

For a 180-degree pull direction, a coated aluminum alloy product 208 produced from this alloy commonly has an average as-rolled (and before coating) and as-cured yield strength of at least about 25 ksi, even more commonly of at least about 28 ksi and even more commonly of at least about 30 ksi and commonly of no more than about 35 ksi, an average as-rolled (and before coating) and as-cured tensile strength of at least about 30 ksi, even more commonly of at least about 32 ksi, and even more commonly of at least about 34 ksi, and commonly of no more than about 46 ksi, an average earing of no more than about 5% and even more commonly of no more than about 4.5%, an average PMT of at least about 400° F., even more commonly of at least about 410° F., and even more commonly of at least about 420° F., and/or an elongation of at least about 2%, even more commonly of at least about 6%, and even more commonly of at least about 7%.

A 5017 series-based alloy useful for producing closure stock has the following composition:

(i) from about 0.45 to about 0.80%, even more commonly from about 0.4 to about 0.70, and even more commonly from about 0.5 to about 0.60% by weight manganese;

(ii) from about 1 to about 2.2%, even more commonly from about 1.2 to about 2, and even more commonly from about 1.5 to about 1.9% by weight magnesium;

(iii) from about 0.1 to about 0.30%, even more commonly from about 0.18 to about 0.28, and even more commonly from about 0.16 to about 0.27% by weight copper;

(iv) from about 0.01 to about 0.70%, even more commonly from about 0.015 to about 0.60, and even more commonly from about 0.020 to about 0.50% by weight iron; and

(v) from about 0.01 to about 0.40%, even more commonly from about 0.015 to about 0.35, and even more commonly from about 0.05 to about 0.30% by weight silicon;

(vi) no more than about 0.001% by weight chromium;

(vii) no more than about 0.001% by weight zinc;

(vii) no more than about 0.001% by weight nickel; and

(viii) from about 0.001 to about 0.1%, even more commonly from about 0.005 to about 0.09, and even more commonly from about 0.001 to about 0.08% by weight titanium.

For a 180-degree pull direction, an aluminum alloy product 208 produced from this alloy commonly has an average as-rolled (and before coating) and as-cured yield strength of at least about 25 ksi, even more commonly of at least about 30 ksi and even more commonly of at least about 33 ksi, an average as-rolled (and before coating) and as coated (after coating) tensile strength of at least about 28 ksi, even more commonly of at least about 33 ksi, and even more commonly of at least about 38 ksi, an average earing of no more than about 2% and even more commonly of no more than about 1.8%, an average PMT of at least about 390° F., even more commonly of at least about 400° F., and even more commonly of at least about 410° F., and/or an elongation of at least about 4%, even more commonly of at least about 5%, and even more commonly of at least about 6%.

A 5042 series-based alloy useful for producing body stock has the following composition:

(i) from about 0.20 to about 0.50%, even more commonly from about 0.25 to about 0.45, and even more commonly from about 0.275 to about 0.425% by weight manganese;

(ii) from about 3 to about 4%, even more commonly from about 3.25 to about 3.9, and even more commonly from about 3.5 to about 3.8% by weight magnesium;

(iii) from about 0.001 to about 0.1%, even more commonly from about 0.01 to about 0.09, and even more commonly from about 0.015 to about 0.08% by weight copper;

(iv) from about 0.01 to about 0.35%, even more commonly from about 0.050 to about 0.30, and even more commonly from about 0.075 to about 0.25% by weight iron; and

(v) from about 0.001 to about 0.20%, even more commonly from about 0.01 to about 0.175, and even more commonly from about 0.05 to about 0.15% by weight silicon;

(vi) from about 0.001 to about 0.10%, even more commonly from about 0.01 to about 0.075, and even more commonly from about 0.025 to about 0.050% by weight chromium;

(vii) from about 0.001 to about 0.01% by weight nickel;

(viii) from about 0.001 to about 0.1%, even more commonly from about 0.01 to about 0.09, and even more commonly from about 0.015 to about 0.08% by, weight titanium; and

(ix) from about 0.01 to about 0.25%, even more commonly from about 0.015 to about 0.20, and even more commonly from about 0.025 to about 0.15% by weight zinc.

For a 180-degree direction of pull, an aluminum alloy product 208 produced from this alloy commonly has an average as-rolled (and before coating) and as-cured yield strength of at least about 25 ksi, even more commonly of at least about 31 ksi, and even more commonly of at least about 37 ksi, an average as-rolled (and before coating) and as coated (after coating) tensile strength of at least about 35 ksi, even more commonly of at least about 40 ksi, and even more commonly of at least about 45 ksi, an average earing of no more than about 2% and even more commonly of no more than about 1.8%, an average PMT of at least about 500° F., even more commonly of at least about 515° F., and even more commonly of at least about 525° F., and/or an average elongation of at least about 7%, even more commonly of at least about 8%, and even more commonly of at least about 9%.

A 5042 series-based alloy useful for producing end stock has the following composition:

(i) from about 0.20 to about 0.50%, even more commonly from about 0.25 to about 0.45, and even more commonly from about 0.275 to about 0.425% by weight manganese;

(ii) from about 3 to about 4%, even more commonly from about 3.25 to about 3.9, and even more commonly from about 3.5 to about 3.8% by weight magnesium;

(iii) from about 0.001 to about 0.1%, even more commonly from about 0.01 to about 0.09, and even more commonly from about 0.015 to about 0.08% by weight copper;

(iv) from about 0.01 to about 0.35%, even more commonly from about 0.050 to about 0.30, and even more commonly from about 0.075 to about 0.25% by weight iron; and

(v) from about 0.001 to about 0.20%, even more commonly from about 0.01 to about 0.175, and even more commonly from about 0.05, to about 0.15% by weight silicon;

(vi) from about 0.0001 to about 0.01%, even more commonly from about 0.001 to about 0.0075, and even more commonly from about 0.0025 to about 0.0050% by weight chromium;

(vii) from about 0.001 to about 0.01% by weight nickel;

(viii) from about 0.001 to about 0.1%, even more commonly from about 0.01 to about 0.09, and even more commonly from about 0.015 to about 0.08% by weight titanium; and

(ix) from about 0.01 to about 0.25%, even more commonly from about 0.015 to about 0.20, and even more commonly from about 0.025 to about 0.15% by weight zinc.

For a 180-degree direction of pull, an aluminum alloy product 208 produced from this alloy commonly has an average as-rolled (and before coating) and as coated (after coating) yield strength of at least about 27 ksi, even more commonly of at least about 31 ksi, and even more commonly of at least about 36 ksi, an average as-rolled (and before coating) and as coated (after coating) tensile strength of at least about 35 ksi, even more commonly of at least about 40 ksi, and even more commonly of at least about 45 ksi, an average earing of no more than about 5% and even more commonly of no more than about 4%, an average PMT of at least about 400° F., even more commonly of at least about 410° F., and even more commonly of at least about 420° F., and/or an average elongation of at least about 7%, even more commonly of at least about 8%, and even more commonly of at least about 9%.

A 5042SP series-based alloy useful for producing tab stock has the following composition:

(i) from about 0.20 to about 0.50%, even more commonly from about 0.25 to about 0.45, and even more commonly from about 0.275 to about 0.425% by weight manganese;

(ii) from about 2.5 to about 4%, even more commonly from about 2.75 to about 3.9, even more commonly from about 2.8 to about 3.9%, and even more commonly from about 3 to about 3.8 by weight magnesium;

(iii) from about 0.001 to about 0.1%, even more commonly from about 0.01 to about 0.09, and even more commonly from about 0.015 to about 0.08% by weight copper;

(iv) from about 0.01 to about 0.35%, even more commonly from about 0.050 to about 0.30, and even more commonly from about 0.075 to about 0.25% by weight iron; and

(v) from about 0.001 to about 0.20%, even more commonly from about 0.01 to about 0.175, and even more commonly from about 0.05 to about 0.15% by weight silicon;

(vi) from about 0.0001 to about 0.01%, even more commonly from about 0.001 to about 0.0075, and even more commonly from about 0.0025 to about 0.0050% by weight chromium;

(vii) from about 0.001 to about 0.01% by weight nickel;

(viii) from about 0.001 to about 0.1%, even more commonly from about 0.01 to about 0.09, and even more commonly from about 0.015 to about 0.08% by weight titanium; and

(ix) from about 0.01 to about 0.25%, even more commonly from about 0.015 to about 0.20, and even more commonly from about 0.025 to about 0.15% by weight zinc.

For a 180-degree direction of pull, a coated aluminum alloy product 208 produced from this alloy commonly has an average as-rolled (and before coating) and as coated (after coating) yield strength of at least about 30 ksi, even more commonly of at least about 31 ksi, and even more commonly of at least about 33 ksi, and commonly no more than about 42 ksi, an average as-rolled (and before coating) and as coated (after coating) tensile strength of at least about 38 ksi, even more commonly of at least about 40 ksi, and even more commonly of at least about 42 ksi, and commonly no more than about 50 ksi, an average PMT of at least about 415° F., even more commonly of at least about 425° F., and even more commonly of at least about 435° F., and/or an average elongation of at least about 5%, even more commonly of at least about 9%, and even more commonly of at least about 10%.

In the above AA5352, 5182, 5042, and 5017 alloys, the balance is primarily aluminum and the primary alloying element reduced by low temperature curing is magnesium. In other alloy compositions, low temperature curing can reduce the levels of other alloying elements required to realize the required mechanical properties.

The aluminum alloy sheet 200 is uncoiled in step 204 on an unwinder or decoiler to produce an uncoiled sheet 212. Generally, the thickness of the aluminum alloy sheet ranges from about 0.007 to about 0.215 inches.

In step 208, the uncoiled sheet 212 is cleansed with a wash water solution and an acid or alkaline solution (typically a mineral acid or a caustic (such as sodium or potassium hydroxide)) to remove contaminants from the surface and form a cleaned sheet 220. Typical contaminants from by the wash water solution include metal particles, dirt, and oil, grease, and other lubricants from gauge reduction operations and by the acid or alkaline solution include metal oxide deposits, particularly of the alloying metals, that can interfere with downstream coating operations. Brushes may be used to physically remove contaminants or the sheet may be abraded by flap sanders to further enhance the surface. A water wash, such as by spray nozzles, typically follows application of the acid or alkaline solution.

The cleaned sheet 220 may be dried (not shown) by any suitable technique. The temperature of the drying step is typically well below the recrystallization temperature of the alloy, more typically is less than about 200° C., and even more typically is no more than about 100° C. In one configuration, pairs of opposed air knives (not shown) and/or squeegees are used to blow the rinse water off of both surfaces of the aluminum alloy sheet. Compressed air, which is heated as a result of compression, is commonly supplied to the air knives.

The cleaned sheet 220 is optionally pretreated by a chemical conversion coating in step 224 to produce a pretreated sheet 228. The conversion coating is formed by “converting” a surface of the sheet into a tightly adherent coating, part of which includes an oxidized form of aluminum. Chemical conversion coatings provide high corrosion resistance and improved bonding affinity for polymer coatings. Typical conversion coatings include chromium, titanium, hafnium, silicon, and/or zirconium and are formed by techniques known to one of ordinary skill in the art. One technique is to contact the sheet with an aqueous solution containing, for example, hexavalent and/or trivalent chromium ions, phosphate ions, titanium ions, hafnium ions, silicon, zirconium ions, halide ions, surfactants, and/or polymers, such as polyacrylic acid, by a pair of interacting rollers (not shown) for picking up pretreatment solution from the reservoir and applying it to one side of the sheet. The rollers respectively associated with the pretreatment solution reservoirs are on opposite sides of the sheet and therefore apply the solution to both sides of the sheet as it moves through the pretreatment application device.

In one configuration, the pretreatment solution applied to the sheet is dried by moving the sheet through an oven (not shown), that commonly uses infrared or radiant heating elements. The temperature of the drying oven is typically well below the recrystallization temperature of the alloy, more typically is less than about 200° C., and even more typically is no more than about 100° C.

Although the cleaned sheet 220 or pretreated sheet 228, as the case may be, is typically not primed before coating application, a primer, such as the vinyl phosphonic acid-acrylic acid copolymer (VPA-AA copolymer) of U.S. Pat. No. 6,696,106, may, in certain applications, be employed to enhance adhesion of the coating to the aluminum alloy sheet. The VPA-AA copolymer reacts with the oxide or hydroxide coating on the pretreated sheet 228 to form a primer layer on the sheet surface. If a primer is employed, it can be applied by dipping the sheet into the primer composition or the primer composition is roll coated or sprayed onto the sheet.

In step 232, the cleaned sheet 220 or pretreated sheet 228, as the case may be, is coated with a suitable (e.g., food-grade) electron beam (“EB”) and/or ultraviolet (“UV”) curable coating composition to form a coated sheet 236. Radiation curable polymer precursors are monomeric and/or oligomeric materials, such as acrylics, methacrylates, epoxies, polyesters, polyols, glycols, silicones, urethanes, vinyl ethers, and combinations thereof which have been modified to include functional groups and optionally photoinitiators that trigger polymerization, commonly cross-linking, upon application of UV or EB radiant energy. Radiation curable polymer precursors are monomeric and/or oligomeric materials such as acrylics, acrylates, acrylic acid, alkenes, allyl amines, amides, bisphenol A diglycidylether, butadiene monoxide, carboxylates, dienes, epoxies, ethylenes, ethyleneglycol diglycidylether, fluorinated alkenes, fumaric acid and esters thereof, glycols, glycidol, itaconic acid and esters thereof, maleic anhydride, methacrylates, methacrylonitriles, methacrylic acid, polyesters, polyols, propylenes, silicones, styrenes, styrene oxide, urethanes, vinyl ethers, vinyl halides, vinylidene halides, vinylcyclohexene oxide, conducting polymers such as dimethylallyl phosphonate, organometallic compounds including metal alkoxides (such as titanates, tin alkoxides, zirconates, and alkoxides of germanium and erbium), and combinations thereof, which have been modified to include functional groups and optionally photoinitiators that trigger polymerization upon the application of ultraviolet (UV) or electron beam (EB) radiant energy. Such polymer precursors include acrylated aliphatic oligomers, acrylated aromatic oligomers, acrylated epoxy monomers, acrylated epoxy oligomers, aliphatic epoxy acrylates, aliphatic urethane acrylates, aliphatic urethane methacrylates, allyl methacrylate, amine-modified oligoether acrylates, amine-modified polyether acrylates, aromatic acid acrylate, aromatic epoxy acrylates, aromatic urethane methacrylates, butylene glycol acrylate, silanes, silicones, stearyl acrylate, cycloaliphatic epoxides, cyclohexyl methacrylate, dialkylaminoalkyl methacrylates, ethylene glycol dimethacrylate, epoxy methacrylates, epoxy soy bean acrylates, fluoroalkyl (meth)acrylates, glycidyl methacrylate, hexanediol dimethacrylate, hydroxyethyl methacrylate, hydroxypropyl methacrylate, isodecyl acrylate, isoctyl acrylate, oligoether acrylates, polybutadiene diacrylate, polyester acrylate monomers, polyester acrylate oligomers, polyethylene glycol dimethacrylate, stearyl methacylate, triethylene glycol diacetate, trimethoxysilyl propyl methacrylate, and vinyl ethers. A typical curable coating composition includes from about 30 to about 60 wt. % reactive oligomer and from about 20 to about 40 wt. % reactive monomers.

The typical polymer precursors are acrylate-based coating compositions. Such compositions typically include oligomers containing urethane groups that can be prepared to meet a wide range of cured film properties. Generally, a mixture of monofunctional (one acrylate group) and polyfunctional (more than one acrylate group) acrylates is used to optimize cured film properties and liquid coating cure speed. Compared to polyfunctional acrylates, monofunctional monomers more effectively reduce viscosity and cured film shrinkage while increasing the elasticity of the cured film. However, a high concentration of monofunctional monomer can severely reduce coating cure speed. In contrast, highly functionalized monomers increase coating cure speed and increase cured film resistance to abrasion. An exemplary coating composition is Durethane™ produced by the Coatings and Resins Group of PPG Industries, Inc.

Photoinitiators are materials which absorb UV and EB radiant energy and form reactive free radicals, cations, or anions which initiate polymerization of the monomeric and oligomeric materials. In UV curing, photoinitiators absorb light in two wavelength ranges, namely approximately 250 and 365 nm. Photoinitiators include acryloins, ketones, substituted benzoquinones, substituted polynuclear quinones, halogenated aliphatic, alicyclic and aromatic hydrocarbons, and mixtures thereof. Photoinitiators may not be necessary for use with polymeric precursors that contain functional groups that are sufficiently reactive to polymerize upon irradiation particularly with EB radiation. Examples of such polymeric precursors include acrylate compositions. In EB curing, cationically-cured compositions can require a small amount of acid producing photoinitiator. Curable coatings typically include from about 1 to about 10 wt. % of a photoinitiator.

The polymer coating composition may also optionally contain additives such as dyes, pigment particles, anticorrosion agents, antioxidants, adhesion promoters, light stabilizers, lubricants, and mixtures thereof. Typically, the coating composition includes about 5 wt. % or less of other additives.

The coating composition may be applied to one or both sides of the sheet by any of several techniques, including gravure coating, slot coating, forward roll coating, reverse roll coating, spraying, powder coating, and electrostatic coating. The coating composition is commonly sequentially applied (one-side-at-a-time) to each side of the metal sheet as a single layer. Commonly, each side of the sheet is coated with the coating composition to a thickness of about 0.01-0.5 mils (1-13 microns).

Typically, the curable coating on each side is separately cured by EB or UV radiation in step 240 to form a cured sheet 244. While UV curing is performed by illuminating the coating with light, EB curing is performed by exposing the coating to high-energy electrons. In one configuration, steps 232 and 240 are sequentially done to a first side of the sheet and then sequentially done to a second side of the sheet. Thus, two each of coating and curing devices are required. In other configurations, steps 232 and 240 are sequentially performed on both sides of the sheet.

Any suitable EB source may be employed, with scanning electron beam, continuous electron beam, and continuous compact electron beam EB sources being common. A typical EB source includes a high voltage supply that provides power to an electron gun assembly, positioned within an optional vacuum chamber having a foil window for passing electrons. Many coatings require a low oxygen environment during EB curing to cure or polymerize the coating. In such cases, nitrogen gas is pumped into the chamber to displace oxygen. Suitably positioned rollers positioned at the entrance and exit guide the movement of the sheet through the device. An exemplary EB source is disclosed in copending U.S. Ser. No. 12/401,269, filed Mar. 10, 2009, which is incorporated herein by this reference. Another EB source is manufactured by RPC Industries.

The EB source commonly produces an electron beam of about 1,000 Kv or less, even more commonly of about 500 Kv or less, even more commonly ranging from about 50 to about 400 Kv, and even more commonly ranging from about 80 to about 300 Kv. The higher the voltage, the deeper the electrons penetrate into the coated substrate. The depth of cure for an EB coating density of about 1 g/cm³ typically ranges from about 1 to about 20 mils and even more typically from about 1.5 to about 10 mils. For scanning electron beam and continuous electron beam EB sources, the current typically is no more than about 2,000 ma, even more typically no more than about 1,500 ma, and even more commonly ranges from about 50 to about 1,000 ma.

UV curing can be performed by any suitable UV source. Typical sources include electrode, electrodeless, and xenon light sources. Electrode and electrodeless light sources commonly have a wattage/inch ranging from about 150 to about 750 to produce an irradiance of from about 5 to about 15 watts/inch² while xenon lamps commonly produce an irradiance ranging from about 1,500 to about 2,500 watts/inch².

UV and EB curing are a function of energy density and line speed. The UV source should provide a dose or radiant energy density of between about 0.5 to about 3.0 Joules/cm². The EB source should be operated at the voltage that is optimum for the density of the coating being cured. Too high a voltage will result in most of the electrons passing through the coating without effecting a cure. Too low a voltage will result in too few electrons penetrating the coating layer. A typical power rating for a EB curing unit is about 1,000 Megarad (Mrad) meter/minute. This means the EB unit delivers 1 Mrad at a line speed of about 1,000 meter/minute. For example, decreasing the line speed by 50% doubles the applied EB dose required for curing. A typical EB dose used for EB curing is between about 0.5 and 20 Mrads and more typically from about 5 to about 15 Mrads, and a typical line speed (and coater head speed) is more than about 1,000 ft/min, more typically at least about 1,250 ft/min, and even more typically ranges from more than about 1,500 to about 2,000 ft/min. In contrast, a conventional coating line has a maximum line speed of about 1,000 ft/min and a typical line speed in the range of about 500 to about 600 ft/min. Unlike radiant or inductive heating, the radiation curing step does not result in any substantial temperature increase in the coating or recrystallization in the alloy, and the mechanical properties of the sheet are not changed by curing. The coating temperature is less than about 250° F. (121° C.) after curing.

The cured sheet 244 is lubricated in optional step 248 to produce a lubricated sheet 252. Any suitable lubricant can be employed. Exemplary lubricants include oil and wax.

In step 256, the lubricated sheet 256 or cured sheet 244, as the case may be, is recoiled on a winder or coiler to form the aluminum alloy product 208.

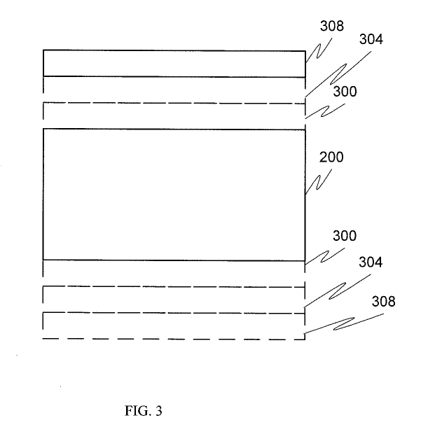

The aluminum alloy product 208 is depicted in FIG. 3. The product 208 includes the aluminum alloy sheet 200, an optional conversion coating 300 applied in step 224, an optional primer 304 applied in step 224, and the cured coating 308 applied in step 232 and cured in step 240. As shown, one or more of the various coatings may be applied to the other size of the aluminum alloy sheet 200.

Compared to conventional coating lines with high temperature thermal curing, the lower temperature coating process discussed above is commonly substantially free of recrystallization and sheet deformities during steps 204, 216, 224, 232, 240, 248, and 256 and can maintain mechanical properties of the aluminum alloy sheet 200 substantially constant throughout the coating process. By way of illustration, a conventional coating line cures in a radiant oven at a temperature typically of at least about 350° F. and even more typically ranging from about 400° F. to 500° F. (peak metal temperature) (which can be above the recrystallization temperature of the aluminum alloy), compared to a temperature increase typically of no more than about 50° F., even more typically of no more than about 25° F., even more typically of no more than about 10° F., and even more typically of no more than about 5° F. in the coating and curing steps 232 and 240.

As a result, the mechanical properties of yield strength and tensile strength of the aluminum alloy sheet 200 commonly differ no more than about 5%, even more commonly no more than about 2.5%, even more commonly no more than about 1%, and even more commonly no more than about 0.5% from the same mechanical property of the aluminum alloy product 208. The mechanical properties of elongation, and earing of the aluminum alloy sheet 200 commonly differ no more than about 20%, even more commonly no more than about 15%, even more commonly no more than about 10%, and even more commonly no more than about 5% from the same mechanical property of the aluminum alloy product 208. Stated another way (and for the same alloy composition), the drop in as-rolled (and before coating) mechanical properties compared to the as coated (after coating) properties is commonly no more than about 7.5 ksi, more commonly no more than about 6 ksi, more commonly no more than about 5 ksi, more commonly no more than about 4 ksi, more commonly no more than about 3 ksi, more commonly no more than about 3 ksi, more commonly no more than about 2 ksi, and even more commonly no more than about 1 ksi for tensile strength and commonly no more than about 6.5 ksi, more commonly no more than about 5.5 ksi, more commonly no more than about 5 ksi, more commonly no more than about 4 ksi, more commonly no more than about 3 ksi, more commonly no more than about 3 ksi, more commonly no more than about 2 ksi, and even more commonly no more than about 1 ksi for yield strength.

Unlike conventionally coated aluminum alloy stock, the elongation of the aluminum alloy product 208 is typically less than and not greater than the as-rolled (and before coating) elongation. For conventional coating processes, the percent elongation of the as-rolled (and before coating) stock is typically at least about 1% less than the percent elongation of the as coated (after coating) stock. In contrast, the percent elongation of the as-rolled (and before coating) stock, using the curing process discussed herein, is typically at least about 0.1%, more typically at least about 0.25%, more typically at least about 0.5% greater than the percent elongation of the as coated (after coating) stock.

### EXPERIMENTAL

The following examples are provided to illustrate certain embodiments of the aspects, embodiments, and/or configurations and are not to be construed as limitations on the aspects, embodiments, and/or configurations, as set forth in the appended claims. All parts and percentages are by weight unless otherwise specified.

### Example I

A continuously cast 5352 series aluminum alloy sheet was provided. The sheet contained about 0.10 wt. % silicon, 0.17 wt. % iron, 0.03 wt. % copper, 0.10 wt. % manganese, and 2.61 wt. % magnesium. The mechanical properties of the sheet were as-rolled (and before coating) tensile strength of 40.8 ksi, an as-rolled (and before coating) yield strength of 35.9 ksi, and an elongation of 8.12%. A first portion of the alloy sheet was coated with a curable coating composition and cured by an electron beam. A different second portion of the alloy sheet was coated with a conventional coating and cured in a radiant oven at a temperature of 390-470° F.

The EB cured aluminum alloy sheet had an as coated (after coating) tensile strength of 39.7 ksi, an as coated (after coating) yield strength of 35.1 ksi, and an elongation of 6.7%.

The conventionally coated and cured aluminum alloy sheet had an as coated (after coating) tensile strength of 39.1 ksi, an as coated (after coating) yield strength of 33.7 ksi, and an elongation of 6.1%.

### Example II

A continuously cast 5182 SP series aluminum alloy sheet was provided. The sheet contained about 0.14 wt. % silicon, 0.23 wt. % iron, 0.07 wt. % copper, 0.26 wt. % manganese, and 4.86 wt. % magnesium.

The as coated (after coating) tensile, yield, and elongation properties of the aluminum alloy sheet in 45° and 0/180° are shown in Table 1. Table 1 further shows the same (as coated (after coating)) mechanical properties of the aluminum alloy sheet after conventional coating and oven curing.

TABLE 1
5182 ES Endstock Data

| coil # F-17-0018 | Si | Fe | Cu | Mn | Mg |
|---|---|---|---|---|---|
| test # 13699 | 0.14 | 0.23 | 0.07 | 0.26 | 4.86 |
| Alloy 5182 SP | | | | | |

| | | Yield | Elongation |
|---|---|---|---|
| | Tensile (ksi) | (ksi) | (%) |
| As Rolled (before coating) in coming | 61.3 | 54.7 | 7.3 |
| properties in 45 degree | | | |
| Conventional coated (after coating) | 51.1 | 46.1 | 11.7 |
| properties in 45 degree | | | |
| As Rolled in coming properties in | 63.8 | 59.01 | 5.2 |
| 0/180 degree | | | |
| Conventional coated (after coating) | 55.6 | 47.5 | 8.1 |
| properties in 0/180 degree | | | |

As can be seen from Table 1, a significant deterioration in the mechanical properties of the aluminum alloy sheet occurred during coating and curing.

### Example III

A continuously cast 5182 ES series aluminum alloy sheet was provided. The sheet contained about 0.13 wt. % silicon, 0.22 wt. % iron, 0.11 wt. % copper, 0.03 wt. % manganese, and 4.93 wt. % magnesium.

The as-rolled (and before coating) and as coated (after coating) tensile, yield, and elongation properties of the aluminum alloy sheet in 45° and 0/180° are shown in Table 2. Table 2 further shows the same (as coated (after coating)) mechanical properties of the aluminum alloy sheet after conventional coating and oven curing.

TABLE 2

| coil # G-42-008 | Si | Fe | Cu | Mn | Mg |
|---|---|---|---|---|---|
| test # 13714 | 0.13 | 0.22 | 0.11 | 0.03 | 4.93 |
| alloy 5182 ES | | | | | |

| | Tensile | Yield | Elongation |
|---|---|---|---|
| | (ksi) | (ksi) | (%) |
| As Rolled (before coating) in coming | 62.0 | 55.5 | 6.5 |
| properties in 45 degree | | | |
| Conventional coated (after coating) | 53.9 | 48.6 | 14.7 |
| properties in 45 degree | | | |
| As Rolled in coming properties in 0/180 | 66.9 | 63.9 | 4.3 |
| degree | | | |
| Conventional coated (as coated (after | 57.5 | 50.1 | 6.7 |
| coating)) properties in 0/180 degree | | | |

As can be seen from Table 2, a significant deterioration in the mechanical properties of the aluminum alloy sheet occurred during coating and curing.

### Example IV

A continuously cast 5042 series aluminum alloy sheet was provided. The sheet contained about 0.11 wt. % silicon, 0.21 wt. % iron, 0.05 wt. % copper, 0.24 wt. % manganese, and 3.79 wt. % magnesium.

The as-rolled (and before coating) and as coated (after coating) tensile, yield, and elongation properties of the aluminum alloy sheet in 45° and 0/180° are shown in Table 3. Table 3 further shows the same (as coated (after coating)) mechanical properties of the aluminum alloy sheet after application and curing of an EB-curable coating.

TABLE 3

| | Tensile | Yield | Elongation |
|---|---|---|---|
| | (ksi) | (ksi) | (%) |
| As Rolled (before coating) in coming | 54.4 | 49.4 | 8.8 |
| properties in 45 degree | | | |
| EB coated (after coating) properties in 45 | 53.1 | 47.8 | 7.8 |
| degree | | | |
| As Rolled (before coating) in coming | 57.8 | 53.9 | 5.1 |
| properties in 0/180 degree | | | |
| EB coated (after coating) properties in 0/180 | 56.9 | 53.2 | 5.5 |
| degree | | | |

As can be seen from Table 3, though the mechanical properties of the aluminum alloy sheet decreased, the decrease was significantly less than that experienced in Examples I, II, and III.

### Example V

A continuously cast 5182LM series aluminum alloy sheet was provided. The sheet contained about 0.13 wt. % silicon, 0.24 wt. % iron, 0.08 wt. % copper, 0.27 wt. % manganese, and 4.26 wt. % magnesium.

The as-rolled (and before coating) tensile, yield, and elongation properties of the aluminum alloy sheet in 45° and 0/180° are shown in Table 4. Table 4 further shows the same mechanical properties of the aluminum alloy sheet after application and curing of an EB-curable coating.

TABLE 4

| coil # I-08-26 | Si | Fe | Cu | Mn | Mg |
|---|---|---|---|---|---|
| test # 13732 | 0.13 | 0.24 | 0.08 | 0.27 | 4.26 |
| Alloy 5182 LM | | | | | |

| | Tensile | Yield | Elongation |
|---|---|---|---|
| | (ksi) | (ksi) | (%) |
| As Rolled (before coating) in coming | 56.2 | 50.3 | 8.8 |
| properties in 45 degree | | | |
| EB coated (after coating) properties in 45 | 55.2 | 49.2 | 8.4 |
| degree | | | |
| As Rolled (before coating) in coming | 60.3 | 55.7 | 5.8 |
| properties in 0/180 degree | | | |
| EB coated (after coating) properties in 0/180 | 58.76 | 54.3 | 5.8 |
| degree | | | |

As can be seen from Table 4, though the mechanical properties of the aluminum alloy sheet decreased, the decrease was significantly less than that experienced in Examples I, II, and III.

### Example VI

A continuously cast 5182FE series aluminum alloy sheet was provided. The sheet contained about 0.12 wt. % silicon, 0.21 wt. % iron, 0.05 wt. % copper, 0.28 wt. % manganese, and 4.59 wt. % magnesium.

The as-rolled (and before coating) tensile, yield, and elongation properties of the aluminum alloy sheet in 45° and 0/180° are shown in Table 5. Table 5 further shows the same (as coated (after coating)) mechanical properties of the aluminum alloy sheet after application and curing of an EB-curable coating.

TABLE 5

| coil # I-15-26 | Si | Fe | Cu | Mn | Mg |
|---|---|---|---|---|---|
| test #13733 | 0.12 | 0.21 | 0.05 | 0.28 | 4.59 |
| Alloy 5182 FE | | | | | |

| | Tensile | Yield | Elongation |
|---|---|---|---|
| | (ksi) | (ksi) | (%) |
| As Rolled (before coating) in coming | 58.6 | 52.1 | 9.3 |
| properties in 45 degree | | | |
| EB coated (after coating) properties in 45 | 57.6 | 51.1 | 9.2 |
| degree | | | |
| As Rolled (before coating) in coming | 61.7 | 57.1 | 5.8 |
| properties in 0/180 degree | | | |
| EB coated (after coating) properties in 0/180 | 61.8 | 57.3 | 5.9 |
| degree | | | |

As can be seen from Table 5, though the mechanical properties of the aluminum alloy sheet decreased, the decrease was significantly less than that experienced in Examples I, II, and III.

### Example VII

The standard compositional range for a 5182 series alloy is 0.20 max wt. % silicon, 0.35 wt. % max iron, 0.15 wt. % max copper, 0.20 to 0.50 wt % manganese, and 4.0 to 5.0 wt. % magnesium.

Table 6 provides the maximum and minimum yield and tensile strengths and minimum elongation.

TABLE 6
Normal customer endstock requirements

| alloy 5182 | Si | Fe | Cu | Mn | Mg |
|---|---|---|---|---|---|
| | .20 max | .35 max | .15 max | .20-.50 | 4.0-5.0 |

| | | | | min |
|---|---|---|---|---|
| | Max | min | Min | Elongation |
| | Yield (ksi) | Yield (ksi) | Tensile (ksi) | (%) |
| 45 direction | 52.5 | 48.5 | 54.0 | 5.0 |

| | Yield (ksi) | Tensile (ksi) | Elongation (%) |
|---|---|---|---|
| 45 Target | 50.5 | 55.5 | 9.5 |
| 0 direction | 50 | 57.5 | 7.0 |

Compared to the mechanical properties of Table 6, the 5182 series alloys of Examples II and III, after conventional coating and oven curing, are noncompliant. In contrast, the 5182 series alloys of Examples V and VI are compliant.

### Example VIII

A coating supplied by Watson Standard was applied to a coil and electron beam cured. The samples were submitted to a can-making company. The samples were reported to have coating weights of 7.0 mg/in² on one side and 2.0 mg/in² on the other side.

A standard coating evaluation was conducted including: MEK resistance, pencil hardness, cross-hatch adhesion, and SEM evaluation. In addition to these tests a Dowfax (Joy) resistance and retort ability were tested. The results are listed in the Table 7 below.

TABLE 7
Coating properties of the samples submitted.

| | | Measurements | |
|---|---|---|---|
| Property | | 2.0 mg/in² side | 7.0 mg/in² side |
| MEK rubs¹ | | 9 | 35 |
| Pencil Hardness² | | H | B-HB |
| Cross- | Pasteurization Test³ | Pass | Fail (Adhesion loss) |
| Hatch | Dowfax (Joy) test⁴ | Pass | Fail (Adhesion loss) |
| Adhesion | Retort ends⁵ | Pass | Pass |
| | Retort panels⁵ | Pass | Fail (Blushing) |

Various details are important to an understanding of Table 7. MEK rubs are counted as double rubs along a sample. Pencil hardness values are from softest to hardest B-HB-F-H-2H-3H etc. and rated as the hardest lead not to scratch the coating. The samples were immersed in reagent grade water heated to 150° F. for 45 minutes. The samples were then removed, cross-hatched, tape applied, and then the tape was removed. The samples were immersed in a boiling solution of 3 L of reagent grade water with 5 ml of Joy for 15 minutes. The samples were then removed, cross-hatched, tape applied, and then the tape was removed. The samples were retorted in an autoclave unit at 250° F. for 30 minutes. The samples were then removed, cross-hatched, tape applied, and then the tape was removed. The reason that there was no adhesion loss in the retort samples may be due to the fact that the samples had time to cool down before cross-hatch testing.

The MEK resistance of the 2.0 mg/in² side were low (average of 9 rubs). The MEK resistance of the 7.0 mg/in² side was acceptable (average of 35 rubs).

The pencil hardnesses were slightly softer than typical coatings.

The 2.0 mg/in² side passed the pasteurization, Dowfax, and retort tests with no observed adhesion loss or blushing.

The 7 mg/in² side had adhesion loss in the pasteurization and Dowfax tests, which is not acceptable. The 7.0 mg/in² retort tests yielded isolated areas of blushing, which is also not acceptable. The 7.0 mg/in² side coating was also tacky after retort.

Two panels were roll coated for evaluation of coating uniformity. One panel was coated with 2.0 mg/in² and the other panel was coated with 7.0 mg/in². Incomplete coverage was observed with the 2.0 mg/in² coating. This would yield high ME (metal exposure) readings when tested with the enamel rater. Complete coverage was observed with the 7.0 mg/in² sample. To further verify the ME exposure, a drop of copper sulfate was place on the both the 2.0 mg/in² and the 7.0 mg/in² side. The 2.0 mg/in² side reacted with the copper sulfate. The 7.0 mg/in² side was fully protected from the copper sulfate because it was completely coated. To summarize, the 2.0 mg/in² side was not fully coated leading to areas of metal exposure; the 2.0 mg/in² side had low MEK rubs; and the 7.0 mg/in² side had adhesion loss during the Dowfax and pasteurization tests and blushing during the retort test, which are not acceptable.

A number of variations and modifications of the aspects, embodiments, and/or configurations can be used. It would be possible to provide for some features without providing others.

In other embodiments, an alloy product having an alloy composition other than that set forth above may be coated and cured by the above process. Other aluminum alloys, for example, may be used for other applications, such as foil products (e.g., cooler fins), plate, castings, body stock, building products, transportation products, and wrought products, such as forgings and stampings. Additionally, other alloy products with alloy compositions including, but not limited to, copper alloys, zinc alloys, and iron alloys, such as tempered steel commonly referred to as “tin plate” may be coated and cured by the above process.

In other embodiments, the process is applied to other aluminum alloys having magnesium as a significant alloying element.

The present disclosure includes components, methods, processes, systems and/or apparatus substantially as depicted and described herein, including various aspects, embodiments, configurations, subcombinations and subsets thereof. Those of skill in the art will understand how to make and use the aspects, embodiments, and/or configurations after understanding the present disclosure. The present disclosure, in various aspects, embodiments, and configurations, includes providing devices and processes in the absence of items not depicted and/or described herein or in various aspects, embodiments, and configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the aspects, embodiments, and/or configurations to the form or forms disclosed herein. In the foregoing Detailed Description for example, various features are grouped together in one or more aspects, embodiments, and configurations for the purpose of streamlining the disclosure. The features of the aspects, embodiments, and configurations may be combined in alternate aspects, embodiments, and/or configurations other than those discussed above. This method of disclosure is not to be interpreted as reflecting an intention that the claimed aspects, embodiments, and/or configurations require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred aspect, embodiment, and/or configuration.

Moreover, though the present disclosure has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A process, comprising:
(a) receiving a cast aluminum alloy sheet, the aluminum alloy sheet comprising:
no more than about 6 wt. % magnesium;
no more than about 1.8 wt. % by weight manganese;
no more than about 0.50 wt. % copper;
no more than about 1.8 wt. % silicon;
no more than about 0.40 wt. % chromium;
no more than about 2.8 wt. % zinc;
no more than about 0.10 wt. % nickel;
no more than about 1 wt. % iron;
no more than about 0.20 wt. % titanium; and
no more than about 0.15 wt. % other impurities;
(b) applying a coating composition to the aluminum alloy sheet; and
(c) curing the coating composition by at least one of ultraviolet light and an electron beam to form a coated aluminum alloy sheet.

2. The process of claim 1, wherein the aluminum alloy sheet comprises:
no more than about 0.20 wt. % magnesium;
no more than about 0.30 wt. % by weight manganese;
no more than about 0.35 wt. % copper;
no more than about 0.10 wt. % silicon;
no more than about 0.10 wt. % chromium;
no more than about 0.50 wt. % zinc;
no more than about 0.10 wt. % iron; and
no more than about 0.05 wt. % other impurities; and
wherein the coated aluminum alloy sheet has an as-rolled (and before coating) and as coated (after coating) yield strength of at least about 7 ksi, an as-rolled (and before coating) and as coated (after coating) tensile strength of at least about 10 ksi, and an elongation of at least about 2%, and wherein an as-rolled (and before coating) and as coated (after coating) yield strength of the aluminum alloy sheet differs no more than about 5% than the as-rolled (and before coating) and as coated (after coating) yield strength of the coated aluminum alloy sheet, and an as-rolled (and before coating) and as coated (after coating) yield strength of the aluminum alloy sheet differs no more than about 5% than the as-rolled (and before coating) and as coated (after coating) yield strength of the coated aluminum alloy sheet.

3. The process of claim 1, wherein an aluminum alloy sheet comprises:
from about 2.0 to about 5.0% by weight magnesium;
from about 0.10 to about 1.25% by weight manganese;
from about 0.001 to about 0.45% by weight copper;
from about 0.1 to about 0.85% by weight iron;
from about 0.1 to about 1.3% by weight silicon;
from about 0.01 to about 0.3% by weight chromium;
from about 0.75 to about 2.7% by weight zinc;
from about 0.001 to about 0.045% by weight nickel; and
from about 0.01 to about 0.175 wt. % titanium; and
wherein the coated aluminum alloy sheet has an as-rolled (and before coating) and as coated (after coating) yield strength of at least about 15 ksi, an as-rolled (and before coating) and as coated (after coating) tensile strength of at least about 22 ksi, and an elongation of at least about 2%.

4. The process of claim 1, wherein the aluminum alloy sheet comprises:
from about 1.5 to about 3% by weight magnesium;
from about 0.001 to about 0.10% by weight manganese;
from about 0.001 to about 0.12% by weight copper;
from about 0.01 to about 0.30% by weight iron;
from about 0.01 to about 0.20% by weight silicon;
from about 0.001 to about 0.10% by weight chromium;
from about 0.001 to about 0.10% by weight zinc; and
from about 0.001 to about 0.10% by weight titanium; and
wherein, for a 180-degree pull direction, the coated aluminum alloy sheet has an average as-rolled (and before coating) and as coated (after coating) yield strength of at least about 20 ksi, an average as-rolled (and before coating) and as coated (after coating) tensile strength of at least about 30 ksi, an average earing of no more than about 2%, an average peak metal temperature (“PMT”), of at least about 400° F., and an average elongation of at least about 4%.

5. The process of claim 1, wherein the aluminum alloy sheet comprises:
from about 2.0 to about 3% by weight magnesium;
from about 0.001 to about 0.10% by weight manganese;
from about 0.001 to about 0.12% by weight copper;
from about 0.01 to about 0.30% by weight iron;
from about 0.01 to about 0.20% by weight silicon;
from about 0.001 to about 0.10% by weight chromium;
from about 0.001 to about 0.10% by weight zinc; and
from about 0.001 to about 0.10% by weight titanium; and
wherein, for a 180-degree pull direction, the coated aluminum alloy sheet has an average as-rolled (and before coating) and as coated (after coating) yield strength of at least about 25 ksi, an average as-rolled (and before coating) and as coated (after coating) tensile strength of at least about 30 ksi, an average earing of no more than about 5%, an average peak metal temperature (“PMT”) of at least about 400° F., and an average elongation of at least about 3%.

6. The process of claim 1, wherein the aluminum alloy sheet comprises:
from about 2.0 to about 3% by weight magnesium;
from about 0.001 to about 0.12% by weight manganese;
from about 0.001 to about 0.1% by weight copper;
from about 0.01 to about 0.30% by weight iron; and
from about 0.01 to about 0.15% by weight silicon;
from about 0.001 to about 0.10% by weight chromium;
from about 0.001 to about 0.10% by weight zinc; and
from about 0.001 to about 0.10% by weight titanium; and
wherein, for a 180-degree pull direction, the coated aluminum alloy sheet has an average as-rolled (and before coating) and as coated (after coating) yield strength of at least about 15 ksi, an average as-rolled (and before coating) and as coated (after coating) tensile strength of at least about 25 ksi, an average earing of no more than about 2%, an average peak metal temperature (“PMT”) of at least about 400° F., and/or an average elongation of at least about 7%.

7. The process of claim 1, wherein the aluminum alloy sheet comprises:
from about 0.20 to about 0.50% by weight manganese;
from about 4.0 to about 4.95% by weight magnesium;
from about 0.001 to about 0.15% by weight copper;
from about 0.01 to about 0.35% by weight iron; and
from about 0.01 to about 0.20% by weight silicon;
from about 0.01 to about 0.25% by weight chromium;
from about 0.01 to about 0.25% by weight zinc;
from about 0.001 to about 0.01% by weight nickel; and
from about 0.001 to about 0.1% by weight titanium; and
wherein, for a 45-degree pull direction, the coated aluminum alloy sheet has an average as-rolled (and before coating) and as coated (after coating) yield strength of at least about 35 ksi, and no more than about 52.5 ksi, an average as-rolled (and before coating) and as coated (after coating) tensile strength of at least about 45 ksi, and no more than about 59 ksi, an average earing of no more than about 5%, an average peak metal temperature (“PMT”) of at least about 400° F., and an elongation of at least about 5%, and, for a 180 degree pull direction, the coated aluminum alloy sheet has an average yield strength in the range of from about 46 to about 57 ksi and an average tensile strength in the range of from about 53 to about 59 ksi.

8. The process of claim 1, wherein the aluminum alloy sheet comprises:
from about 0.20 to about 0.50% by weight manganese;
from about 4.0 to about 5% by weight magnesium;
from about 0.001 to about 0.1% by weight copper;
from about 0.01 to about 0.35% by weight iron;
from about 0.01 to about 0.20% by weight silicon;
from about 0.01 to about 0.25% by weight chromium;
from about 0.01 to about 0.25% by weight zinc;
from about 0.001 to about 0.01% by weight nickel; and
from about 0.001 to about 0.1% by weight titanium; and
wherein, for a 180-degree pull direction, the coated aluminum alloy sheet has an average as-rolled (and before coating) and as coated (after coating) yield strength of at least about 35 ksi, and no more than about 49 ksi, an average as-rolled (and before coating) and as-cured tensile strength of at least about 40 ksi, and no more than about 60 ksi, an average peak metal temperature (“PMT”) of at least about 400° F., and an average elongation of at least about 5%.

9. The process of claim 1, wherein the aluminum alloy sheet comprises:
from about 0.20 to about 0.50% by weight manganese;
from about 4 to about 5% by weight magnesium;
from about 0.001 to about 0.1% by weight copper;
from about 0.01 to about 0.35% by weight iron;
from about 0.001 to about 0.20% by weight silicon;
from about 0.001 to about 0.1% by weight chromium;
from about 0.001 to about 0.01% by weight nickel;
from about 0.001 to about 0.1% by weight titanium; and
from about 0.01 to about 0.25% by weight zinc; and
wherein, for a 180-degree direction of pull, the coated aluminum alloy sheet has an average as-rolled (and before coating) and as-cured yield strength of at least about 35 ksi, an average as-rolled (and before coating) and as-cured tensile strength of at least about 45 ksi, an average peak metal temperature (“PMT”) of at least about 400° F., and an average elongation of at least about 5%.

10. The process of claim 1, wherein the aluminum alloy sheet comprises:
from about 0.45 to about 0.80% by weight manganese;
from about 1.5 to about 2.25% by weight magnesium;
from about 0.1 to about 0.30% by weight copper;
from about 0.01 to about 0.70% by weight iron;
from about 0.01 to about 0.40% by weight silicon;
no more than about 0.001% by weight chromium;
no more than about 0.001% by weight zinc;
no more than about 0.001% by weight nickel; and
from about 0.001 to about 0.1% by weight titanium,
wherein, for a 180-degree pull direction, the coated aluminum alloy sheet has an average as-rolled (and before coating) and as-cured yield strength of at least about 25 ksi, an average as-rolled (and before coating) and as-cured tensile strength of at least about 30 ksi, an average earing of no more than about 2%, an average peak metal temperature (“PMT”) of at least about 500° F., and an elongation of at least about 5.5%.

11. The process of claim 1, wherein the aluminum alloy sheet comprises:
from about 0.45 to about 0.80% by weight manganese;
from about 1 to about 2.25% by weight magnesium;
from about 0.1 to about 0.30% by weight copper;
from about 0.01 to about 0.70% by weight iron;
from about 0.01 to about 0.40% by weight silicon;
no more than about 0.001% by weight chromium;
no more than about 0.001% by weight zinc;
no more than about 0.001% by weight nickel; and
from about 0.001 to about 0.1% by weight titanium; and
wherein, for a 180-degree pull direction, the coated aluminum alloy sheet has an average as-rolled (and before coating) and as-cured yield strength of at least about 25 ksi and of no more than about 35 ksi, an average as-rolled (and before coating) and as-cured tensile strength of at least about 30 ksi and of no more than about 46 ksi, an average earing of no more than about 5%, an average peak metal temperature (“PMT”) of at least about 400° F., and an elongation of at least about 2%.

12. The process of claim 1, wherein the aluminum alloy sheet comprises:
from about 0.45 to about 0.80% by weight manganese;
from about 1 to about 2.2% by weight magnesium;
from about 0.1 to about 0.30% by weight copper;
from about 0.01 to about 0.70% by weight iron; and
from about 0.01 to about 0.40% by weight silicon;
no more than about 0.001% by weight chromium;
no more than about 0.001% by weight zinc;
no more than about 0.001% by weight nickel; and
from about 0.001 to about 0.1% by weight titanium.
wherein, for a 180-degree pull direction, the aluminum alloy sheet has an average as-rolled (and before coating) and as-cured yield strength of at least about 25 ksi, an average as-rolled (and before coating) and as coated (after coating) tensile strength of at least about 28 ksi, an average earing of no more than about 2% an average peak metal temperature (“PMT”) of at least about 390° F., and an elongation of at least about 4%.

13. The process of claim 1, wherein the aluminum alloy sheet comprises:
from about 0.20 to about 0.50% by weight manganese;
from about 3 to about 4% by weight magnesium;
from about 0.001 to about 0.1% by weight copper;
from about 0.01 to about 0.35% by weight iron;
from about 0.001 to about 0.20% by weight silicon;
from about 0.001 to about 0.10% by weight chromium;
from about 0.001 to about 0.01% by weight nickel;
from about 0.001 to about 0.1% by weight titanium; and
from about 0.01 to about 0.25% by weight zinc; and
wherein, for a 180-degree direction of pull, the coated aluminum alloy sheet has an average as-rolled (and before coating) and as-cured yield strength of at least about 25 ksi, an average as-rolled (and before coating) and as coated (after coating) tensile strength of at least about 35 ksi, an average earing of no more than about 2%, an average peak metal temperature (“PMT”) of at least about 500° F., and an average elongation of at least about 7%.

14. The process of claim 1, wherein the aluminum alloy sheet comprises:
from about 0.20 to about 0.50% by weight manganese;
from about 3 to about 4% by weight magnesium;
from about 0.001 to about 0.1% by weight copper;
from about 0.01 to about 0.35% by weight iron;
from about 0.001 to about 0.20% by weight silicon;
from about 0.0001 to about 0.01% by weight chromium;
from about 0.001 to about 0.01% by weight nickel;
from about 0.001 to about 0.1% by weight titanium; and
from about 0.01 to about 0.25% by weight zinc.
wherein, for a 180-degree direction of pull, the coated aluminum alloy sheet has an average as-rolled (and before coating) and as coated (after coating) yield strength of at least about 27 ksi, an average as-rolled (and before coating) and as coated (after coating) tensile strength of at least about 35 ksi, an average earing of no more than about 5%, an average peak metal temperature (“PMT”) of at least about 400° F., and an average elongation of at least about 7%.

15. The process of claim 1, wherein the aluminum alloy sheet comprises:
from about 0.20 to about 0.50% by weight manganese;
from about 2.5 to about 4% by weight magnesium;
from about 0.001 to about 0.1% by weight copper;
from about 0.01 to about 0.35% by weight iron;
from about 0.001 to about 0.20% by weight silicon;
from about 0.0001 to about 0.01% by weight chromium;
from about 0.001 to about 0.01% by weight nickel;
from about 0.001 to about 0.1% by weight titanium; and
from about 0.01 to about 0.25% by weight zinc; and
wherein, for a 180-degree direction of pull, the coated aluminum alloy sheet has an average as-rolled (and before coating) and as coated (after coating) yield strength of at least about 30 ksi, an average as-rolled (and before coating) and as coated (after coating) tensile strength of at least about 38 ksi and no more than about 50 ksi, an average peak metal temperature (“PMT”) of at least about 415° F., and an average elongation of at least about 5%.

16. The process of claim 1, wherein an as-rolled (and before coating) and as coated (after coating) yield strength of the aluminum alloy sheet differs no more than about 5% than the as-rolled (and before coating) and as coated (after coating) yield strength of the coated aluminum alloy sheet, and an as-rolled (and before coating) and as coated (after coating) yield strength of the aluminum alloy sheet differs no more than about 5% than the as-rolled (and before coating) and as coated (after coating) yield strength of the coated aluminum alloy sheet.

17. The process of claim 1, wherein, for a selected as coated (after coating) tensile and/or yield strength, the coated aluminum alloy sheet has a magnesium content that is at least about 0.05 wt. % less than a magnesium content required by a conventionally coated aluminum alloy sheet.

18. The process of claim 1, wherein, for a selected as coated (after coating) tensile and/or yield strength, the coated aluminum alloy sheet has a magnesium content that commonly is at least about 0.4 wt. % less than a magnesium content required by a conventionally coated aluminum alloy sheet.

19. The process of claim 1, wherein a temperature gain through steps (b) and (c) is no more than about 100° F.

20. The process of claim 1, wherein the coating composition is substantially solventless and is substantially free of volatile organic compounds during steps (b) and (c).

21. The process of claim 9, wherein the coating composition contains less than 0.01 VOC/gallon of coating and wherein the coated aluminum alloy sheet is substantially free of a conversion coating.

22. The process of claim 1, wherein the aluminum alloy sheet comprises:
no more than about 1.5 wt. % magnesium;
no more than about 0.10 wt. % zinc; and
no more than about 0.10 wt. % titanium; and
wherein the coated aluminum alloy sheet has an as-rolled (and before coating) and as coated (after coating) yield strength of at least about 11 ksi, an as-rolled (and before coating) and as coated (after coating) tensile strength of at least about 11 ksi, and an elongation of at least about 2%.

23. The process of claim 1, wherein, for a selected as coated (after coating) tensile and/or yield strength, the coated aluminum alloy sheet has a magnesium content that commonly is at least about 0.075 wt. % less than a magnesium content required by a conventionally coated aluminum alloy sheet.

24. The process of claim 1, wherein, for a selected as coated (after coating) tensile and/or yield strength, a coated aluminum alloy sheet has a magnesium content of at least about 0.5 wt. % less than a magnesium content required by a conventionally coated aluminum alloy sheet.

25. The process of claim 1, wherein a temperature gain through steps (b) and (c) is no more than about 50° F.

26. The process of claim 1, wherein, in steps (b) and (c), a line speed is more than about 1,000 ft/min.

27. The process of claim 1, wherein, in steps (b) and (c), the aluminum alloy sheet is substantially free of recrystallization.

28. The process of claim 1, wherein a yield strength and/or tensile strength of the aluminum alloy sheet differs no more than about 5% from a corresponding one of a yield strength and/or tensile strength of the coated aluminum alloy sheet and wherein an elongation and/or earing of the aluminum alloy sheet differs no more than about 20% from corresponding one of an elongation and/or earing of the coated aluminum alloy sheet.

29. The process of claim 1, wherein a drop in as-rolled (and before coating) yield strength and/or tensile strength of the aluminum alloy sheet compared to a corresponding one of a yield strength and/or tensile strength of the coated alloy sheet is no more than about 7.5 ksi.

30. The process of claim 1, wherein an elongation of the aluminum alloy sheet is at least about 0.1% greater than an elongation of the coated aluminum alloy sheet.
